(19) United States
(12) Patent Application Publication
(10) Pub. No.: US 2021/0239261 A1
(43) Pub. Date: Aug. 5, 2021

(54) Undercabinet Bracket for Kitchen Scales

(71) Applicant: Kyle J. Moore, Bethany, OK (US)

(72) Inventor: Kyle J. Moore, Bethany, OK (US)

(21) Appl. No.: 16/779,592

(22) Filed: Feb. 1, 2020

(51) Int. Cl. F16M 13/02

(52) U.S. Cl. CPC F16M 13/02

(57) ABSTRACT

A bracket for holding a platter of a kitchen scale below an overhead cabinet for quickly finding the kitchen scale, easily retrieving it for use, and conveniently returning it to storage, having two opposing slots formed in two side rails separated by a spacer, wherein the spacer provides a minimum width between the slots to receive and hold the kitchen scale platter while also preventing storage of other items, such as wine glasses and large knives, in the bracket.

### FIELD OF THE INVENTION

The present invention relates to kitchen appliance storage devices, and in particular to brackets and holders for kitchen scales.

### BACKGROUND OF INVENTION

Many compact electronic kitchen scales are available on the market today, which are very popular for those who are following diets or monitoring their nutritional intake.

### SUMMARY OF THE EXEMPLARY EMBODIMENTS OF THE INVENTION

A bracket is disclosed for conveniently holding a platter of a kitchen scale below an overhead cabinet for quick location, retrieval, and return to storage, having two opposing slots formed in two side rails separated by a spacer, wherein the spacer provides a minimum width between the slots to receive and hold the kitchen scale platter while also preventing storage of other items, such as wine glasses and large knives.

### BRIEF DESCRIPTION OF THE DRAWINGS

The figures presented herein, when considered in light of this description, form a complete disclosure of one or more embodiments of the invention, wherein like reference numbers in the figures represent similar or same elements or steps.

FIG. 1 provides a perspective view of an example embodiment according to the present invention.

FIGS. 2A, 2B and 2C illustrate, for reference, a typical kitchen scale from perspective, side and front views, respectively.

FIG. 3 provides an end view to illustrate a cross section of the example embodiment shown in FIG. 1.

FIG. 4 shows the view of FIG. 3 with additional referential dimensional information.

FIG. 5 depicts a manner of use of the embodiment of FIG. 1 with a received kitchen scale, such as that of FIG. 2.

FIG. 6 sets forth a manner of use of the embodiment of FIG. 1 as installed under an overhead cabinet.

FIG. 7 illustrates the view of FIG. 5 in solid form with hidden features, shapes and elements out of view.

FIG. 8 sets forth another embodiment having adjustable spacing between the side rails.

FIG. 9 sets forth yet another embodiment having adjustable spacing between the side rails, and illustrating one or more means for attaching the bracket to an overhead cabinet.

FIG. 10 illustrates another embodiment according to the invention in which the lower lips of the opposing slots taper towards each other.

### DETAILED DESCRIPTION OF ONE OR MORE EXEMPLARY EMBODIMENT(S) OF THE INVENTION

The present inventor has recognized a need in the art that is, as of yet, unsatisfied. While small kitchen scales are in wide use, they often are left on the counter top where they can get in the way of other kitchen activities, or moved into a cabinet where they are difficult to find or even misplace. They typically are only used for a few moments during food preparation, and the remainder of the time, they are either hidden away somewhere or in the way on the counter top. This leads to their being used less and less, and thus any diet plan that depends on continuous and vigilante tracking of nutritional intake can be compromised.

The present inventor has devised a solution for storage of kitchen scales which allows the unit to be stored underneath an overhead cabinet, thereby freeing up the counter top space for other kitchen activities, but also keeping them readily in plain sight and quick to access and return to their storage spot.

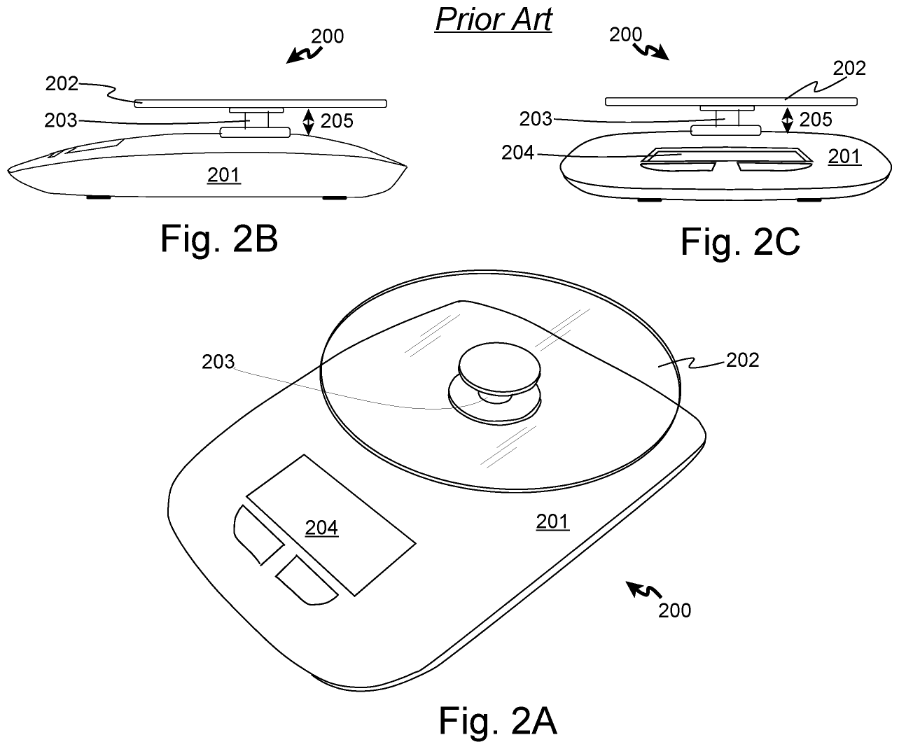

Referring to FIGS. 2A, 2B and 2C, as illustrated by a small kitchen scale presently on the market made by Taylor Precision Products of Seattle, Wash., USA, many of these affordable kitchen scales 200 have a lower housing 201 with a load-receiving element 202 and a single vertical post or support 203, through which the load receiving element which rests on a load cell such as an electronic strain gauge. The strain gauge is read and interpreted by the electronics in the body, to produce a weight reading on a display 204. One or more buttons may be provided to allow the user to turn on and off the scales, and optionally to select units of measurement, input nutrition-per-serving information, etc. Other electronic and analog designs from other manufacturers may have the same physical arrangement with a load receiving element, lower body, and support therebetween. For the remainder of this disclosure, we will refer to the top load receiving element of all kitchen scales as a platter, which shall refer collectively to all scale load receiving elements such as platforms, decks, hoppers, plates and scoops.

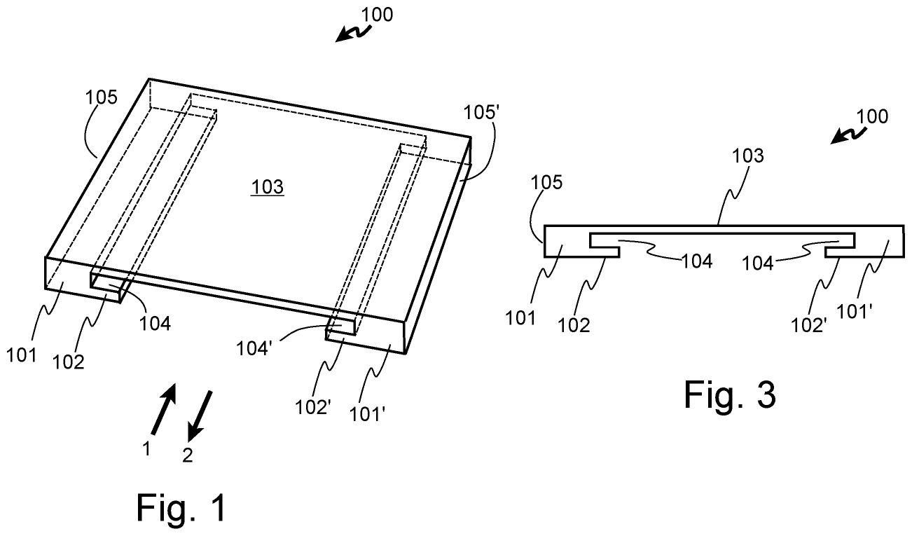

The present inventor has realized that the nearly-universal space 205 provided between the platter 202 and the body 201 presents an opportunity to hold the unit in a bracket, such as an undercabinet storage bracket. Referring now to FIG. 1, one particular embodiment of an undercabinet kitchen scale bracket 100 according to the present invention is shown. In this representation, the dashed lines represent hidden physical shapes and features of this example embodiment. It generally has two side rails 101 and 101′ which provide opposing lips 102 and 102′ between the outer sides 105 and 105′, in which a platter of a kitchen scale can be receive 1 and removed 2 by a sliding action. This particular embodiment has a rail-to-rail spacer 103 which provides a pre-determined spacing between the two side rales 101 and 101′ to properly receive and hold, without dropping the kitchen scale platter.

Referring to FIG. 3, and end view of such an embodiment 100 is show for better understanding of the cross-sectional shape of this embodiment, including the two slots 104 and 104′ formed into the side rails 101 and 101′ and defined by the lips 102 and 102′ with the spacer 103. Such an embodiment may be manufactured using wood and wood shaping techniques, plastic molding, vacuum forming sheet plastic, bending of sheet metal, and forming a frame from bending tubing or bending wire and optionally vinyl coating the wire.

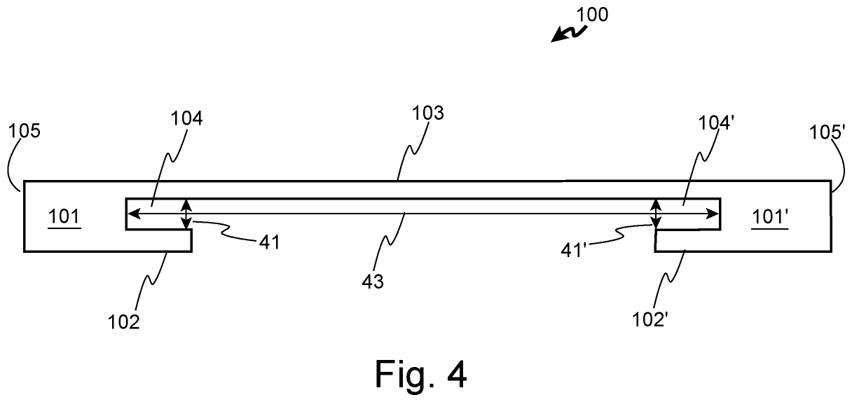

Referring now to FIG. 4, using a similar end view from FIG. 3, more details of the particular dimensions of at least one embodiment are provided. The slots 104 and 104′ are, in one embodiment, slightly taller 41 and 41′ than ⅛ of an inch tall to receive a typical glass platter of a typical electronic kitchen scale, which tend to be about ⅛ thick themselves. While some embodiments may provide a friction fit to receive the platter, most will not and will provide a tall enough slot to allow friction-free insertion and removal of the platter. The rail-to-rail spacer 103, in one embodiment, provides a width 43 between the slots 104 and 104′ of slightly more than 6 inches, to receive a typical glass platter of a typical electronic kitchen scale, which tend to be about 6 inches wide themselves. Other dimensions for other scale designs are possible in other embodiments, of course. This particular example embodiment has a set width to accommodate scales having a 6-inch wide platter of ⅛-inch thick material.

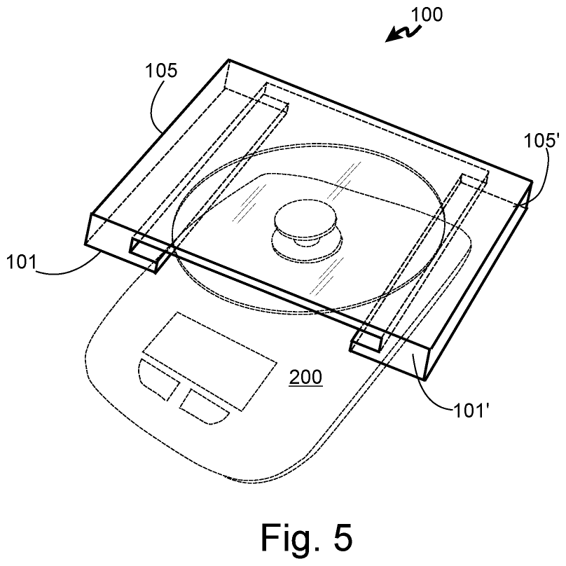

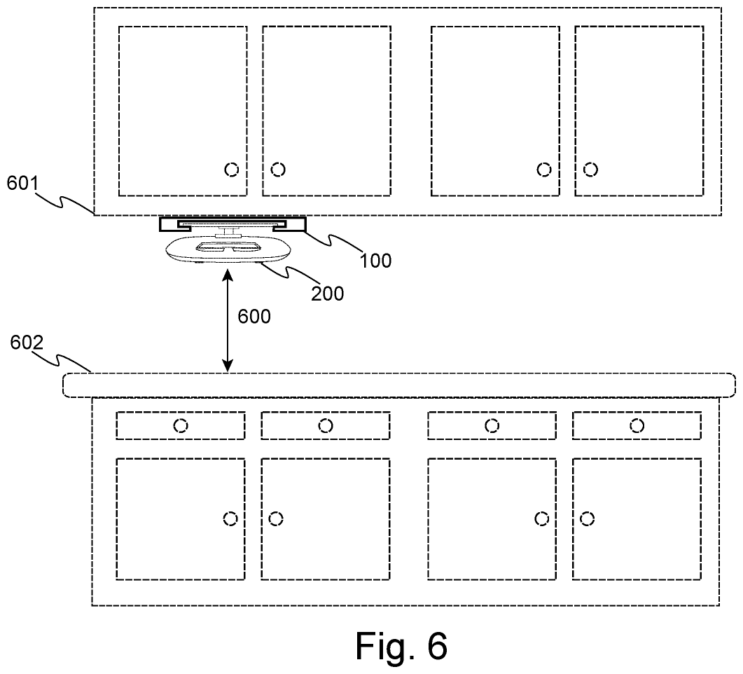

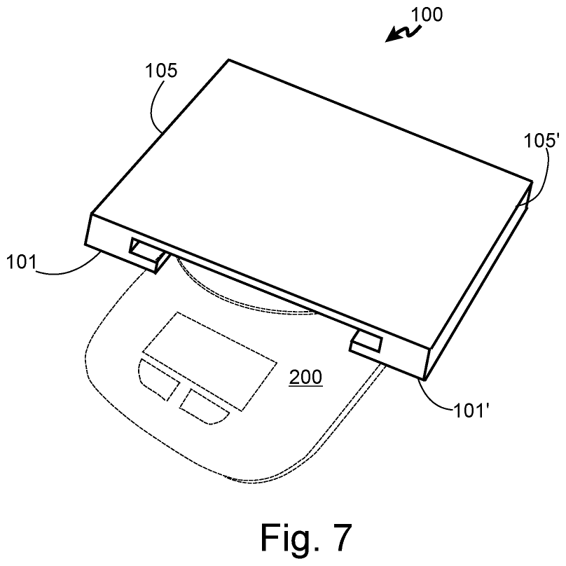

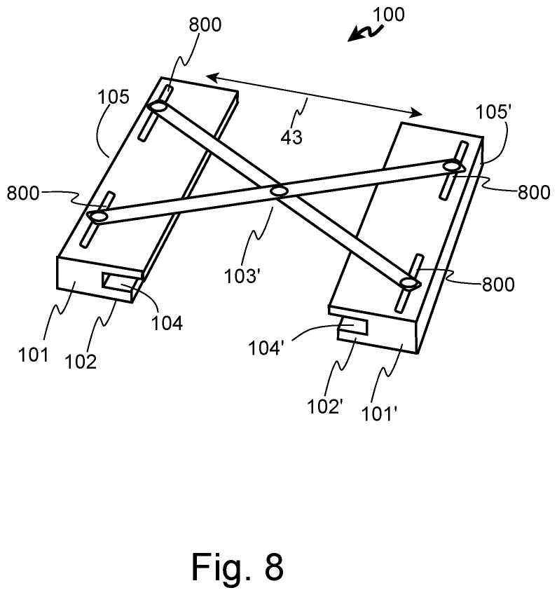

FIG. 5 illustrates an example kitchen scale 200 with a round platter received into the slots of such an embodiment 100, with the dashed lines illustrating hidden mechanical structures and features and elements of the scale itself. FIG. 7 illustrates the same embodiment holding a kitchen scale, however the solid nature of the embodiment is depicted, thereby obscuring the hidden mechanical features and structures. FIG. 6 illustrates the manner of using the example bracket 100 when mounted under some overhead cabinets 601, thereby freeing the cabinet space 602 below the overhead cabinets 601 and the countertop 602 for other purposes and uses. This illustrates the nature of the invention which keeps the scale in view of the cook, allows quick retrieval by sliding it out, placing it on the countertop for measuring, and then easily and quickly returning it to its storage spot by sliding it back into the bracket 100.

In another example embodiment according to the present invention, the rail-to-rail spacer may be adjustable, such as a scissor-style spacer 103′, in which the sliding adjustment slots 800 allow for the rail-to-rail spacing to be changed to match different scale platter widths. The sliding adjustment slots 800 may also prevent the side rails 101 and 101′ from being set too close together to prevent the kitchen scale rack from being used to store other items for which the rack may not be suitable, such as wine glasses, knives, etc. For example, wine glasses vary in height and bowl width according to the type of wine they are intended to hold, however, their bases are generally about 2¼ inches to 2½ inches wide. So, the sliding adjustment slots 800 may be configured to prevent the side rails 101 and 101′ from being closed to a slot-to-slot width 43 of less than 4 inches to prevent attempts to use the bracket to store heavier wine glasses.

While an electronic kitchen scale may weigh only a few ounces, so the materials and mounting means for the scale bracket may be suitable for just such a light weight, a row of wine glasses could exceed the mounting strength or bracket materials strength, and as such, cause the wine glasses to fall. Therefore, a fixed spacer 103 as previously discussed, or a limited adjustable spacer 103′ as discussed here is preferred for most embodiments.

Similarly, the most commonly used knife in a western kitchen is the chef's knife, which is generally 1½ inches to 2 inches tall with a length of 6 to 14 inches. So, an adjustable spacer 103′ with a minimum slot-to-slot width 43 of 4 inches would prevent a user from storing a chef's knife in its slots, which could pose a safety hazard if it were to fall out.

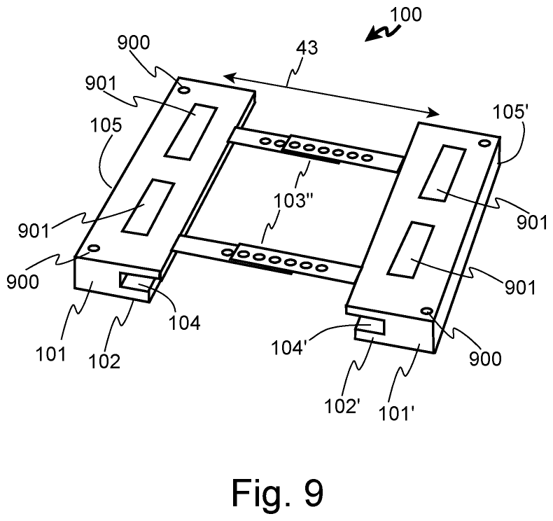

Referring now to FIG. 9, another embodiment of an adjustable spacer 103″ is shown in the form of a set of overlapping cross members with pre-drilled holes, snaps, or other mating connectors that allow pre-determined spacings to be set by the installer. These pre-determined spacings should, according to a preferred embodiment, prevent the slot-to-slot width 43 from being set too close, as previously discussed.

Also shown in FIG. 9 are mounting holes 900 formed through the side rails to allow attachment to an overhead cabinet using fasteners such as screws, nails or rivets. Or, strips 901 of double-sided adhesive tape, hook-and-loop fastener tape, magnetic tape, or removable adhesive tape (e.g., 3M Command™ products) can be employed for mounting, or combinations of fasteners and strips can be used as the means for attachment under an overhead cabinet.

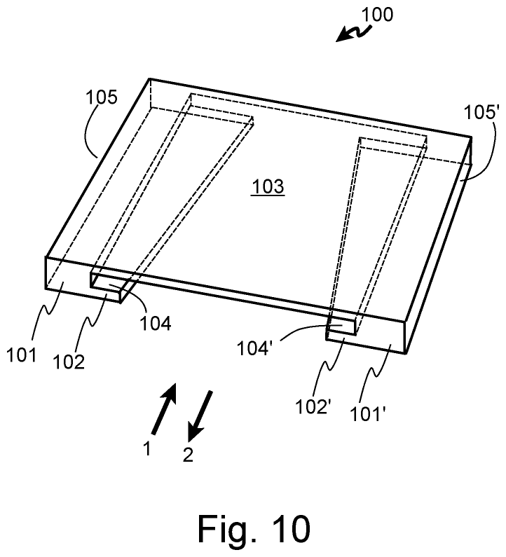

FIG. 10 illustrates another embodiment 100 according to the invention in which the lower lips 102 and 102′ of the opposing slots 104 and 104′ are not parallel, but instead taper towards each other. This allows the bracket to hold a wide range of different kitchen scales with varying widths and shapes of platters, such as round platters and square platters, and with varying diameters of vertical supports under the platters. The scale platter is inserted into the front, widest portion between the slots, and then slid backwards towards the rear of the slots until it is fully captured.

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof, unless specifically stated otherwise.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. The foregoing example embodiments do not define the extent or scope of the present invention, but instead are provided as illustrations of how to make and use at least one embodiment of the invention.

1. A bracket comprising:
a first rail having a first platter slot formed therein and a first sliding adjustment slot;
a second rail having a second platter slot formed therein and a second sliding adjustment slot; and
a scissor-style spacer disposed between the first side rail and the second side rail, engaging the first sliding adjustment slot and the second sliding adjustment slot, configured to hold the first platter slot in opposition to the second platter slot with an adjustable spacing between the first platter slot and the second platter slot;
wherein the adjustable spacing is mechanically limited and configured to receive a platter portion of a kitchen scale.

2. The bracket as set forth in claim 1 wherein the first platter slot and the second platter slot have heights of approximately ⅛ inch.

3. The bracket as set forth in claim 1 wherein a minimum adjustable spacing comprises approximately 4 inches.

4. (canceled)

5. The bracket as set forth in claim 4 wherein the a maximum adjustable spacing comprises approximately 6 inches.

6. (canceled)

7. The bracket as set forth in claim 1 further comprising a kitchen scale, wherein the kitchen scale comprises a platter portion, and wherein the first rail, second rail and adjustable spacer are configured to receive the platter portion of the kitchen scale.

8. (canceled)

9. The bracket as set forth in claim 1 wherein at least one of the rails or the spacer are fabricated from a material selected from the group consisting of wood, metal, plastic, and wire.

10. The bracket as set forth in claim 1 further comprising one or more structural elements selected from the group consisting of a fastener hole formed through at least one side rail, a portion of adhesive tape, a portion of hook-and-loop fastener tape, a magnetic tape, and a removable adhesive tape.

11.-13. (canceled)

14. The bracket as set forth in claim 1 wherein the first platter slot and the second platter slot are defined by a first lower lip and a second lower lip, respectively, and wherein the first lower lip and the second lower lip are essentially parallel.

15. The bracket as set forth in claim 1 wherein the first platter slot and the second platter slot are defined by a first lower lip and a second lower lip, respectively, and where the first lower lip and the second lower lip define a tapering gap therebetween.

16. An undercabinet kitchen scale comprising:
a kitchen scale having a platter portion; and
an undercabinet storage bracket having:
a first rail having a first platter slot formed therein;
a second rail having a second platter slot formed therein; and
a spacer disposed between the first side rail and the second side rail, holding the first platter slot in opposition to the second platter slot with a spacing between the first platter slot and the second platter slot;
wherein the first rail, second rail and spacer are configured to receive the platter portion of the kitchen scale.

17. The undercabinet kitchen scale as set forth in claim 16 wherein the first platter slot and the second platter slot have heights of approximately ⅛ inch.

18. The undercabinet kitchen scale as set forth in claim 16 wherein the spacer provides a fixed spacing between the first platter slot and the second platter slot.

19. The undercabinet kitchen scale as set forth in claim 16 wherein the spacer provides adjustable spacing between the first platter slot and the second platter slot.

20. The undercabinet kitchen scale as set forth in claim 19 wherein the spacer comprises a scissor-style adjustable spacer disposed between the first side rail and the second side rail, engaging a first sliding adjustment slot of the first rail and engaging a second sliding slot of the second sliding adjustment slot, wherein the adjustable spacing is mechanically limited and configured to receive the platter portion of the kitchen scale.

21. The undercabinet kitchen scale as set forth in claim in claim 20 wherein adjustable spacing is limited to a maximum of approximately 6 inches.

22. The undercabinet kitchen scale as set forth in claim further comprising one or more structural elements selected from the group consisting of a fastener hole formed through at least one side rail, a portion of adhesive tape, a portion of hook-and-loop fastener tape, a magnetic tape, and a removable adhesive tape.

23. The undercabinet kitchen scale as set forth in claim 16 wherein the first platter slot and the second platter slot are defined by a first lower lip and a second lower lip, respectively, and wherein the first lower lip and the second lower lip are essentially parallel.

24. The undercabinet kitchen scale as set forth in claim 16 wherein the first platter slot and the second platter slot are defined by a first lower lip and a second lower lip, respectively, and where the first lower lip and the second lower lip define a tapering gap therebetween.
